(19) United States
(12) Patent Application Publication
(10) Pub. No.: US 2026/0332279 A1
(43) Pub. Date: Oct. 22, 2026

(54) METHOD FOR TESTING A RADIO CONNECTION BETWEEN A MOBILE ROBOTIC SYSTEM AND AN EXTERNAL CONTROL UNIT

(71) Applicant: TECHNISCHE UNIVERSITÄT DORTMUND, Dortmund (DE)

(72) Inventors: Prof. Dr. Christian WIETFELD, Dortmund (DE); Dr. Janis TIEMANN, Dortmund (DE); Manuel Steve MBANKEU PATCHOU, Dortmund (DE); Christian ARENDT, Dortmund (DE); Stefan BÖCKER, Dortmund (DE)

(21) Appl. No.: 19/119,329

(22) PCT Filed: Oct. 11, 2023
(86) PCT No.: PCT/EP2023/078109

§ 371 Date: Apr. 8, 2025

(30) Foreign Application Priority Data
Oct. 11, 2022 (DE) 10 2022 126 387.8

(51) Int. Cl. H04B 17/391; H04W 16/22; H04W 24/10

(52) U.S. Cl. CPC H04B 17/3913; H04W 16/22; H04W 24/10

(57) ABSTRACT

A method for testing a radio connection between a mobile robotic system and an external control unit includes the following method steps:
detecting the real environment and creating a virtual environment,
modelling the virtual environment by emulating the material properties of the structure and/or adding further three-dimensional structures with predetermined material properties, a position of the mobile robotic system in the real environment, transferring the position of the mobile robotic system to the virtual environment, modelling a radio propagation of a test signal in the virtual environment depending on the position of the mobile robotic system,
determining modification parameters for adapting a radio signal of the radio connection in the real environment according to the modelled test signal, and adjusting the radio signal according to the modification parameters and sending the adjusted radio signal to the mobile robotic system or the external control unit.

The invention relates to a method for testing a radio connection between a mobile robotic system and an external control unit in a real environment.

Mobile robotic systems, such as driverless transport systems for logistics, robots for rescue or research operations, partially or fully automated motor vehicles, must be extensively tested for their approval or certification. Until now, the focus of the test procedures, in particular for driverless transport systems or robots, was primarily on the mechanical and sensory properties of the robotic systems. This means that a mobile robotic system has to perform certain tasks within a given scenario, such as moving around an obstacle course with ramps and stairs or opening a door and closing a valve. Typically, these tasks are not performed completely autonomously by the mobile robotic system. Rather, a so-called operator is in control, who specifies the tasks and can also directly control certain operations remotely. In this respect, a mobile robotic system must not only have mechanical and sensory abilities, but must also have a sufficiently stable radio connection to the operator or an external control unit. When certifying partially or fully automated motor vehicles, testing the radio connection under challenging conditions is also becoming increasingly important.

Traditionally, however, only simple fault scenarios are considered in such test procedures. These include, for example, a complete loss of communication, an increased packet error rate or various shadowing obstacles that are far from realistically modelled scenarios, such as those that occur in the event of an earthquake or flood due to the destruction of infrastructure. In such cases, completely different communication conditions arise, which mobile robotic systems have to deal with.

The methods known from the state of the art for testing a radio connection of a mobile robotic system do not yet allow complex interference scenarios to be taken into account and, at the same time, a realistic test environment to be created.

On this basis, the object of the invention is to provide a method for testing a radio connection of a mobile robotic system in a real environment, which enables the radio connection to be tested in any modelled test environment, so that even complex interference scenarios can be simulated cost-effectively.

This task is solved by the subject matter of claim 1. Preferred embodiments can be found in the sub-claims.

According to the invention, a method for testing a radio connection between a mobile robotic system and an external control unit in a real environment is provided, wherein the real environment has at least one three-dimensional structure with predetermined material properties, the mobile robotic system and the external control unit each having a communication unit with at least one antenna for transmitting and/or receiving a radio signal, comprising the following method steps:
S1) Detecting the real environment and creating a virtual environment, the virtual environment being a digital twin of the real environment,
S2) Modelling the virtual environment by means of a planning system by emulating the material properties of the structure of the virtual environment and/or adding further three-dimensional structures with predetermined material properties to the virtual environment,
S3) Detecting a position of the mobile robotic system in the real environment by means of an external position-determining system,
S4) Transferring the position of the mobile robotic system in the real environment to the virtual environment,
S5) Modelling radio propagation of a test signal in the modelled virtual environment depending on the position of the mobile robotic system in the virtual environment,
S6) Determining modification parameters for adapting a radio signal of the radio connection in the real environment according to the modelled test signal in the virtual environment, and
S7) Adapting the radio signal according to the modification parameters and sending the adapted radio signal to the mobile robotic system or the external control unit.

When the term ‘real environment’ is used in this context, it refers to a test site on which one or more three-dimensional structures can be arranged. These include, in particular, buildings of different heights or widths, stairs, ramps or simple walls. These three-dimensional structures have physical material properties, such as a density or a surface property. Depending on the material, they can shield or reflect a radio signal differently. A wooden wall, for example, is less problematic for the radio connection than a concrete wall.

In this context, a digital twin is a digital representation of a tangible or intangible environment from the real world in the digital world. It is irrelevant whether the counterpart in the real world already exists or will only exist in the future. The digital twin enables a comprehensive exchange of data. It consists of a model of the represented environment and may also contain simulations, algorithms and services that describe or influence the properties or behaviour of the represented environment.

If the position of the mobile robotic system in the real environment is mentioned, this refers to the location of the mobile robotic system within the real environment. The position is determined by means of an external positioning system. In this context, this refers to an independent positioning system. This means that the position is determined independently of the position determined by the mobile robotic system itself. The independent positioning system can, for example, be a satellite-based system or a camera in whose field of vision the test environment is arranged. The external and independent position determination system enables an adequate reproducibility of the precise position determination of the mobile robotic system as an input parameter for the digital twin, which is absolutely necessary for reproducible testing of a radio connection with high accuracy in very complex and differentiated representations of real environments.

Modelling radio propagation involves, in particular, tracking emitted radio waves from a specific position within the virtual environment. In doing so, shadowing and reflections of the radio waves on three-dimensional structures are taken into account and tracked even after they have hit different surfaces.

When we talk about adjusting the radio signal, we are referring in particular to attenuating the radio signal. This means that the existing real radio signal is physically attenuated so that the signal strength is reduced and adapted to the test signal in the virtual environment. The signal can also be attenuated to such an extent that it is completely suppressed and is therefore no longer available.

It is therefore a key point of the invention that the modelled mechanical environments of a test site can be overlaid with a highly realistic modelling of the radio technical properties of different material properties of the environment. Even if the mechanical environment provided for the mobile robotic system for test purposes has been realised with materials that are less prone to radio interference, such as wood and plastic, an environment consisting of stone, concrete and/or metal, for example, can be radio-emulated and/or supplemented and thus realistically and cost-effectively integrated into the test scenario.

According to a preferred embodiment of the invention, the method comprises the following further steps:
S8) Moving the mobile robotic system in the real environment, and
S9) Repeating steps S3) to S7) in real time.

In the present case, ‘moving’ refers to changing the position or location of the mobile robotic system within the real environment. This is done primarily by moving the mobile robotic system so that the mobile robotic system has a new location and, from there, a new modelling and adaptation of the radio signal is carried out.

Preferably, the radio propagation is modelled using ray tracing. Ray tracing is an algorithm based on the emission of rays for calculating concealment, i.e. for determining the visibility of three-dimensional objects from a specific point in a space. Ray tracing also refers to several extensions of this basic method, which calculate the further path of rays after they hit surfaces.

According to a preferred embodiment of the invention, the position of the mobile robotic system in the real environment is determined by means of GNSS, UWB radio and/or external optical sensors. GNSS is a global navigation satellite system for positioning and navigation on the ground and in the air by receiving signals from navigation satellites and pseudolites. This system is particularly suitable for outdoor use. Indoors, positioning is mainly done using UWB radio or optical sensors. UWB radio is a short-range radio communication option that uses ultra-wideband technology. An important feature here is the use of very large frequency ranges with a bandwidth of at least 500 MHz or at least 20% of the arithmetic mean of the lower and upper cut-off frequency of the frequency range used.

According to a preferred embodiment of the invention, at least one communication unit has electronically controllable attenuators for attenuating the radio signal. The input level of the radio signal can then be adjusted according to the modification parameters and the signal can be transferred to the communication unit with the appropriate electronic controllable attenuation in accordance with the physical attenuation.

According to a preferred embodiment of the invention, the radio connection belongs to a first radio system. The method then comprises the following further method steps:
S2a) Emulating the first radio system of the radio connection by means of the planning system, and
S5a) Determining signal properties of the test signal, wherein the test signal is associated with a second radio system that is different from the first radio system, and
S6a) Adapting the signal properties of the radio signal of the first radio system in the real environment in accordance with the signal properties of the test signal of the second radio system.

The determined physical signal properties of the radio signal are derived as a function of a predetermined radio system by means of corresponding simulation models in communication-related performance indicators, such as preferably data rate, packet error rate and/or latency, and implemented by means of corresponding software at the operating system level for another radio system. Further preferred are the different radio systems selectable from WiFi, LTE, 5G or 6G. With these embodiments, it is consequently possible to reproducibly transfer and/or test the behaviour or influence of radio channel properties to other radio systems, such as LTE or 5G mobile radio.

According to a preferred embodiment of the invention, the method comprises the following further method step:
S5′) Modelling an interference signal and adding the interference signal to the test signal.

In this way, additional potential interference signals caused by other radio-technical devices in the scenario, such as public radio systems or deliberate interferers or so-called jammers, can be taken into account and their effects, such as an increased packet error rate, can be integrated via the modification parameters transmitted to the communication units.

According to the invention, the method described above is also intended for testing and/or certifying mobile robotic systems. Preferably, the mobile robotic systems are semi-autonomous or autonomous rescue robots. In the present case, ‘rescue robotics’ refers to robotic systems that support rescue and emergency services in dangerous situations or hostile environments. For reliable operation, high demands are placed on the radio connection between the rescue robotics and the control unit or the operator, since a large number of shielding obstacles can be expected, especially in inhospitable environments.

In the following, the invention will be explained in more detail on the basis of a preferred embodiment with reference to the drawings.

In the drawings,

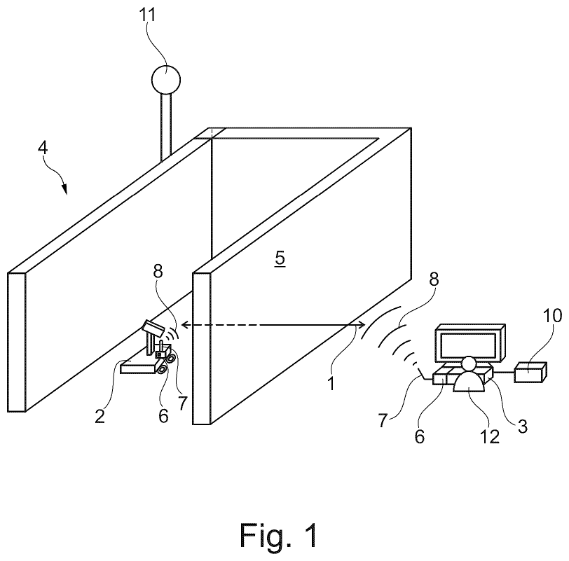

FIG. 1 schematically shows a first test scenario for a method according to a preferred embodiment of the invention,

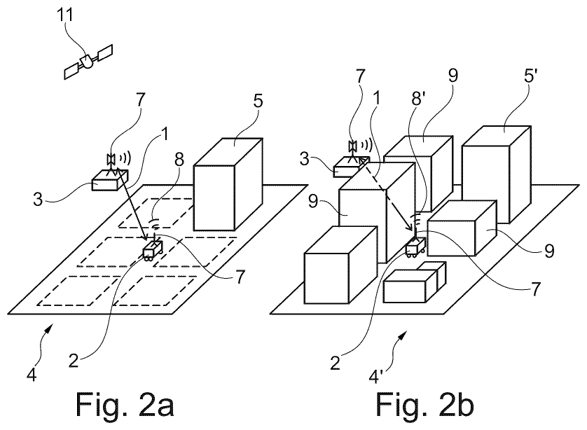

FIGS. 2a, 2b schematically show a second test scenario for a method according to a preferred embodiment of the invention and

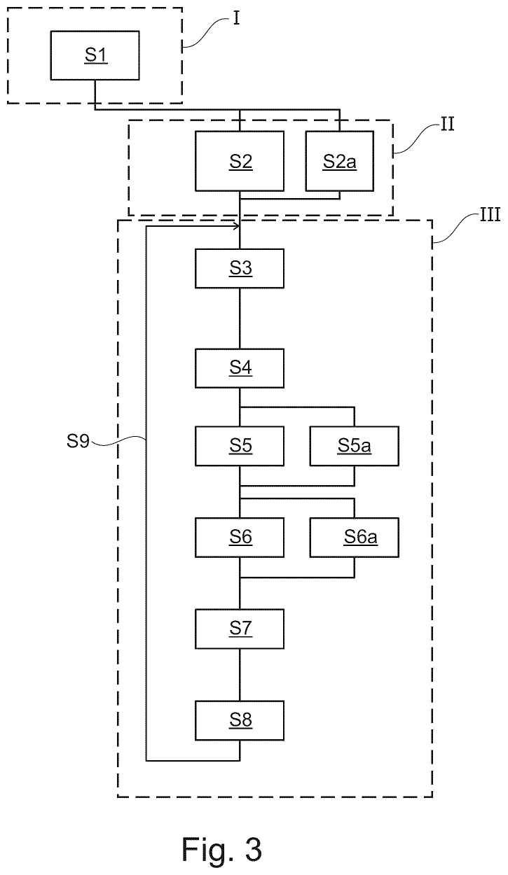

FIG. 3 schematically shows the sequence of a method according to a preferred embodiment of the invention.

FIG. 1 schematically shows a test scenario in an indoor area. The real environment 4 is shown. A three-dimensional structure 5 in the form of a wall is arranged between the mobile robotic system 2 and the control unit 3. Both the mobile robotic system 2 and the control unit 3 have a communication unit 6 with an antenna 7, via which the radio signal 8 can be sent or received, so that a radio connection 1 is established between the mobile robotic system 2 and the control unit 3. The mobile robotic system 2 shown in FIG. 1 is a rescue robot that is partially remote-controlled by an operator 12. The position of the mobile robotic system 2 is determined using a position-determining system 11, shown here in the form of a camera.

The control unit 3 is connected to a planning system 10. The operator 12 can use the planning system 10 to model or emulate the virtual environment 4′ and to model the radio propagation in the virtual environment 4′. Once the radio propagation for a test signal 8′ in the virtual environment 4′ has been determined, the real radio signal 8 can be attenuated via the communication unit 6 in such a way that the real radio signal 8 corresponds to the modelled test signal 8′.

In the scene shown, it is therefore possible to construct an obstacle course with inexpensive polystyrene or wooden walls as the real environment 4 and to subsequently change the material properties in the emulated virtual environment 4′ so that the radio propagation for concrete or metal walls is modelled. The real radio signal 8 that passes through a wooden wall is then attenuated in such a way that it behaves exactly like a radio signal that would pass through a concrete wall. It is also possible to assign the radio signal 8 and the test signal 8′ to different radio systems. In this way, the influence of emulated radio environments can be investigated in a technology-neutral way, for example by emulating a real WiFi radio signal with a 5G test signal. Accordingly, radio propagation can be modelled not only for different virtual environments 4′, but also for different radio systems.

FIGS. 2a and 2b show an outdoor test scenario. In FIG. 2a, the mobile robotic system 2 is located on a real test site in the real environment 4. The radio connection 1 to the control unit 3 is not interrupted. The position of the mobile robotic system 2 is determined by means of an external position-determining system 11, which is shown in FIG. 2a as a satellite for determining the position via a global navigation satellite system. The position of the mobile robotic system 2 is transferred to the virtual environment 4′. FIG. 2b shows the virtual environment 4′, in which further structures 9 have been added and the already existing structure 5′ has been emulated. The test signal 8′ now passes through one of the added structures 9 in the virtual environment 4′, so that the radio connection 1 is not given without attenuation of the test signal 8′. The radio propagation is modelled and the path of the test signal 8′ is followed in the virtual environment 4′. From this, the parameters for modifying the real radio signal 8 can be derived. These modification parameters indicate, for example, a reduced signal strength so that the real radio signal 8 is attenuated in accordance with the modelled shielding of the test signal 8′ in the virtual environment 4′. In this way, the real radio signal 8 can be modelled on an arbitrarily configured and complex virtual environment 4′, without having to replicate this complex virtual environment 4′ in real terms. In addition to the shielding of the test signal 8′, reflections at various surfaces or interferences with added and modelled interference signals can also be realised. However, this is not shown in FIG. 2a and FIG. 2b. Inserting a source of interference into the virtual environment 4′ allows a complex real scenario to be reproduced even more realistically.

FIG. 3 shows the sequence of a method according to an embodiment of the invention. The first section I comprises the step S1, according to which the real environment 4 is reproduced as a digital twin in a virtual environment 4′. This first section is carried out once for each test site or environment.

The second section II comprises the steps S2 and S2a. This section II is carried out once for each test scenario. The step S2 includes the modelling of the virtual environment 4′. This is done by emulating existing structures 5 and their material properties or by adding further structures 9 or jammers. Likewise, the radio system under test can be emulated in step S2a if required. This means that the real radio signal 8 takes on the behaviour and propagation of a test signal 8′ from a different radio system.

The third section III comprises the steps S3 to S9. These are continuously repeated so that the radio propagation can always be determined in real time for each change of position or location of the mobile robotic system 2 within the real environment 4, and the behaviour of the radio signal 8 can be tested in a dynamic scenario.

In the third section III, the position of the mobile robotic system 2 within the real environment 4 is first determined S3 and transferred to the virtual environment 4′ S4. Subsequently, the radio propagation is modelled in the virtual environment 4′ S5. The test signal 8′ is analysed and signal properties, such as latency or packet error rate, are determined. After that, modification parameters are determined for the real radio signal 8, which adjust the real radio signal 8 in the real environment 4 according to the modelled test signal 8′ in the virtual environment 4′ and its signal characteristics S6, S6a. Finally, the real radio signal 8 is adapted using the modification parameters S7 and made available to the communication unit 6 for sending the radio signal 8 to the control unit 3 or from the control unit 3 to the mobile robotic system 2. The above steps take place in real time. The mobile robotic system 2 is then moved so that it changes its position or location S8. The radio propagation is then remodelled and the real radio signal 8 is adjusted again S9.

The invention underlying this patent application was developed as part of the project ‘Establishment of the German Rescue Robotics Centre (DRZ)’ with the funding code 13N14857 and as part of the project ‘6G Research Hub for Open, Efficient and Secure Mobile Communication Systems—6GEM’, with the funding code 16KISK038, which were funded by the German Federal Ministry of Education and Research.

### LIST OF REFERENCES

1 Radio connection
2 Mobile robotic system
3 Control unit
4 Real environment
4′ Virtual environment
5 Structure
5′ Emulated structure
6 Communication unit
7 Antenna
8 Radio signal
8′ Test signal
9 Structure
10 Planning system
11 Position-determining system
12 Operator
I First section
II Second section
III Third section
S1 Detecting the real environment and creating a virtual environment
S2 Modelling the virtual environment
S2a Emulating the first radio system of the radio link
S3 Detecting the position of the mobile robotic system in the real environment
S4 Transferring the position of the mobile robotic system in the real environment to the virtual environment
S5 Modelling radio propagation of a test signal
S5a Determining signal characteristics of the test signal
S5′ Modelling an interference signal and adding the interference signal to the test signal
S6 Determining modification parameters for adapting a radio signal
S6a Adapting the signal characteristics of the radio signal
S7 Adapting the radio signal according to the modification parameters and sending the adapted radio signal
S8 Moving the mobile robotic system
S9 Repeating steps S3) to S7) in real time

1. A method for testing a radio connection between a mobile robotic system and an external control unit in a real environment, wherein the real environment comprises at least one three-dimensional structure with predetermined material properties, the mobile robotic system and the external control unit each having a communication unit with at least one antenna for transmitting and/or receiving a radio signal, comprising:
S1) detecting the real environment and creating a virtual environment, wherein the virtual environment is a digital twin of the real environment,
S2) modelling the virtual environment by means of a planning system by emulating the material properties of the structure of the virtual environment and/or adding further three-dimensional structures with predetermined material properties to the virtual environment,
S3) detecting a position of the mobile robotic system in the real environment by means of an external position-determining system,
S4) transferring the position of the mobile robotic system in the real environment to the virtual environment,
S5) modelling radio propagation of a test signal in the modelled virtual environment depending on the position of the mobile robotic system in the virtual environment,
S6) determining modification parameters for adapting a radio signal of the radio connection in the real environment according to the modelled test signal in the virtual environment, and
S7) adjusting the radio signal according to the modification parameters and sending the adjusted radio signal to the mobile robotic system or the external control unit

2. Method according to claim 1, further comprising:
S8) moving the mobile robotic system in the real environment, and
S9) repeating steps S3) to S7) in real time.

3. Method according to claim 1, wherein the modelling of the radio propagation is carried out by means of ray tracing.

4. Method according to claim 1, wherein the position of the mobile robotic system in the real environment is detected by means of GNSS, UWB radio and/or by means of external optical sensors.

5. Method according to claim 1, wherein at least one communication unit has electronically controllable attenuators for attenuating the radio signal.

6. Method according to claim 1, wherein the radio connection is associated with a first radio system, the method further comprising:
S2a) emulating the first radio system of the radio connection by means of the planning system,
S5a) determining signal properties of the test signal, wherein the test signal is associated with a second radio system that is different from the first radio system, and
S6a) adapting the signal properties of the radio signal (8) of the first radio system in the real environment in accordance with the signal properties of the test signal of the second radio system.

7. Method according to claim 6, wherein the signal properties comprise a data rate and/or a packet error rate and/or a latency.

8. Method according to claim 6, wherein the first radio system and second radio systems can each be selected from the following radio systems: WiFi, LTE, 5G, 6G.

9. Method according to claim 1, further comprising:
S5′) modelling an interference signal and adding the interference signal to the test signal.

10. (canceled)
